(19) United States
(12) Patent Application Publication
(10) Pub. No.: US 2022/0001759 A1
(43) Pub. Date: Jan. 6, 2022

(54) UNDERFLOOR CHARGING UNIT AND VEHICLE HAVING AN UNDERFLOOR CHARGING UNIT

(71) Applicant: Easelink GmbH, Graz (AT)

(72) Inventors: Manuel LEIBETSEDER, Graz (AT); Philipp BERNER, Graz (AT); Martin KÜHHAS, Graz (AT); Hermann STOCKINGER, Graz (AT)

(21) Appl. No.: 17/294,227

(22) PCT Filed: Nov. 15, 2019
(86) PCT No.: PCT/EP2019/081500

§ 371 Date: May 14, 2021

(30) Foreign Application Priority Data
Nov. 16, 2018 (DE) 10 2018 009 010.9

(51) Int. Cl. B60L 53/35; B60L 53/14; B62D 25/24; B62D 25/20; H02J 7/00

(52) U.S. Cl. CPC B60L 53/35; B60L 53/14; H02J 7/0042; B62D 25/20; B62D 25/24

(57) ABSTRACT

An underfloor charging unit, in particular for an electric charging system for an electrically driven vehicle, includes a housing having an upper side and a contacting opening, a cover and a driving device for actuating the cover. The cover covers the contacting opening in a closed position and unblocks the contacting opening in an open position, the driving device being configured so as to move the cover in an automated manner from the closed position to the open position and from the open position to the closed position, the cover, in the closed position, being arranged closer to the upper side than in the open position. A vehicle having an underfloor charging unit is furthermore shown.

### FIELD OF THE INVENTION

The invention relates to an underfloor charging unit, in particular for an electric charging system for an electrically driven vehicle, and to a vehicle having an underfloor charging unit.

### BACKGROUND

For electrically driven vehicles, conductive charging systems are known in which an electric conduction is established in an automated manner between a vehicle-side part (also referred to as vehicle contact unit) and a stationary part fixed to the ground (also referred to as ground contact unit).

To this end, electrical contacts are usually required on the underfloor of the vehicle, which can be brought into contact with the corresponding contact surfaces of the ground contact unit if required.

Irrespective of whether a vehicle contact unit moves from the vehicle towards the ground contact unit or whether the movement occurs from the ground contact unit towards the vehicle, it is necessary to protect the contacts provided on the vehicle underfloor against dirt during travel to avoid losses during charging.

It is thus the object of the invention to provide an underfloor charging unit and a vehicle in which contacts of the underfloor charging unit are sufficiently protected during travel.

### SUMMARY

The invention provides an underfloor charging unit, in particular for an electric charging system for an electrically driven vehicle, comprising a housing having an upper side and a contacting opening, a cover and a driving device for actuating the cover, the cover covering the contacting opening in a closed position and unblocking the contacting opening in an open position, the driving device being configured so as to move the cover in an automated manner from the closed position to the open position and from the open position to the closed position, the cover, in the closed position, being arranged closer to the upper side than in the open position.

The upper side of the housing is the side which in the intended mounting position of the underfloor charging unit is located at the top, for example closest to a roof of the vehicle. The upper side of the housing can also be open or partially opened.

The contacting opening is in particular provided on the lower side opposite the upper side, i.e. on the side of the housing facing away from the vehicle.

The position of the cover relative to the upper side of the housing can for example be defined by the position of the center of mass of the cover.

In the closed position, the cover is for example located closer to the upper side than in the open position by a distance, the distance being greater than the thickness of the cover in the vertical direction.

Due to the fact that the contacting opening is covered by the cover in the closed position, the interior of the housing and thus the contacts present there are mechanically protected. Furthermore, due to the fact that the cover can be moved in an automated manner from the closed position to the open position and from the open position to the closed position, no laborious intervention of a user of the vehicle is required.

In the closed position, the contacting opening is in particular at least partially, particularly entirely covered by the cover. The cover can be mechanically arrested in the closed position.

In the context of this invention, “unblock” means that the contacting opening is accessible for the most part, in particular for more than 80%.

In the open position, the cover is for example arranged parallel to the housing.

The underfloor charging unit is preferably provided on the vehicle underfloor of the electrically driven vehicle. The movement of the cover preferably occurs parallel to the vehicle underfloor or to a lower side of the housing. The driving device is for example provided in the interior of the housing.

For example, the underfloor charging unit includes contacts for charging the vehicle which are covered by the cover in the closed position. The contacts may be brought into electrical contact with mating contacts—such as contact surfaces of a ground contact unit—to charge the vehicle. It is possible to move a vehicle contact unit which supports contacts through the contacting opening, for example out of the interior of the housing. Alternatively, a ground contact unit having contact surfaces can be moved through the contacting opening into the interior of the housing to make contact with the contacts.

Examples for electrically driven vehicles are battery-driven vehicles (BEV), plug-in hybrid vehicles (PHEV) and fuel cell vehicles (FCEV).

In one configuration of the invention, the housing includes several parts such as half-shells and has for example a two-box design. The housing may have further openings such as ventilation openings in addition to the contacting opening.

The driving device is for example configured so as to move the cover both in the vertical direction, for example by a translational movement, and in the horizontal direction, for example by a rotational movement.

The movements in the vertical direction and in the horizontal direction may, but need not be separate from each other, as in a pivoting movement.

In one embodiment of the invention, the driving device is configured to move the cover from the driving device translationally and/or rotationally about an axis of rotation, the driving device being in particular configured to first move the cover translationally in a direction of translation away from the interior of the housing and then to move the cover rotationally about an axis of rotation to the open position to transfer the cover from the closed position to the open position. The space necessary for the movement of the cover from the closed position to the open position can thus be kept to a minimum. In particular, no space-intensive pivoting movements about a pivot axis parallel to the vehicle underfloor are necessary.

Preferably, the axis of rotation and/or the direction of translation run perpendicularly to the cover and/or to the contacting opening to further reduce the required space.

The axis of rotation is in particular parallel to the direction of translation. The cover can always be parallel to the housing, in particular to the outer surface or the underfloor plane during the rotational movement.

In a further embodiment, the cover has a plurality of cover parts which are movable relative to each other, in particular overlap each other. The required installation space which is necessary for the cover in the open position can thus be reduced. The cover can for example be configured as an iris diaphragm.

The cover can have an outer side and an inner side to protect the driving unit by the cover, the cover being connected to the driving device on the inner side. The outer side can be the side facing away from the interior of the housing, and the inner side the side of the cover facing the interior of the housing.

One aspect of the invention provides that the contacting opening is delimited by a marginal area of the housing, the underfloor charging unit having a sealing lip which is arranged between the cover and the marginal area in the closed position and which surrounds, in particular entirely surrounds the contacting opening, as a result of which the interior of the housing is reliably protected in the closed position. In the closed position, no liquids and/or dirt can thus enter the interior of the housing due to the sealing lip.

The sealing lip is for example made of rubber, felt and/or is a bead, a blade, a hollow profile or a brush. In the closed position, the sealing lip can be located axially between the cover and the marginal area and/or can be fastened to the marginal area or to the cover.

In case of a two-piece sealing lip, the sealing lip may also be fastened to the marginal area and to the cover.

In a further configuration of the invention, the underfloor charging unit has a guide, in particular a slotted link and/or a shaft bearing which guides the movement of the cover, which ensures a reliable movement of the cover.

To improve the service life of the underfloor charging unit, the sealing lip can surround the guide in the closed position.

In a further embodiment, the housing includes an outer surface having a recess, the contacting opening being provided in the recess, the cover having in particular the same contour as the recess. It is thus possible to provide a receptacle, in particular with stops, for the cover in the closed position.

The outer surface is in particular provided on a lower side of the underfloor charging unit.

In a space-saving design, the recess has a bottom, at least parts of the bottom forming a marginal area of the housing which delimits the contacting opening.

The bottom of the recess is in particular offset towards the interior of the housing with respect to the outer surface. A further opening such as a functional opening for the driving device and/or a ventilation opening may be provided within the recess, in particular in the bottom of the recess.

Preferably, the cover is completely received in the recess in the closed position, which reduces the air resistance during travel.

In the closed position, the outer side of the cover is flush with the outer surface.

To protect the driving unit against dirt, the driving device may be provided in the region of the recess in the interior of the housing, particularly in a view perpendicular onto the opening.

In one embodiment of the invention, the driving device includes at least one assembly for generating the movement of the cover, the driving device in particular including a first assembly for generating the translational movement and a second assembly for generating the rotational movement. It is thus possible to design the driving device with standard components.

In one variant embodiment, the driving device includes a first slotted link and a different second slotted link, in which a common guide pin is guided, the first slotted link being movable relative to the second slotted link such that complex sequences of movement of the cover are possible.

In particular, only one assembly and/or one electric motor of the driving unit is required in this case. The complex sequence of movement may for example comprise a substantially translational movement and a substantially rotational movement separate therefrom.

The cover is preferably fastened to the guide pin.

In one variant embodiment, the first slotted link is provided on a slotted link component and the second slotted link is provided on a slotted link wall, the slotted link wall surrounding the slotted link component in the circumferential direction, and the slotted link component being rotatable relative to the slotted link wall, or vice versa, the relative movement of the slotted links being thus realized in a simple manner.

The slotted link component is preferably cylindrical or conical and may also be configured so as to be hollow.

The slotted link wall is for example stationary relative to the housing, and/or the slotted link component may be driven by an electric motor.

In a further embodiment of the invention, the underfloor charging unit has a closure device for arresting the cover in the closed position, the closure device being in particular arranged substantially diametrically opposed to the driving device with respect to the contacting opening. The cover can be securely arrested in the closed position by the closure device.

The closure device is for example arranged in the interior of the housing. The closure device may also be integrated in the cover.

Closure means which engage each other in the closed position may for example be fastened to the parts of the cover or to different cover parts.

Furthermore, the sealing lip can also surround the closure device in the closed position of the cover.

The cover includes for example a closure area, in particular a closure recess having an undercut which is arranged in the region of the closure device in the closed position, the closure device in particular having a locking element which engages in the closure area, in particular in the undercut. A simple but mechanically secure arresting can thus be achieved.

To reliably engage the undercut, the locking element may have an elongated base body and a lip, the lip being provided at the end of the base body which faces the cover. The lip surrounds the base body preferably only partially in the circumferential direction.

In one variant embodiment, the underfloor charging unit includes a vehicle contact unit having contacts which is arranged in the housing, the vehicle contact unit being in particular adapted to be moved out of the underfloor charging unit through the contacting opening. An electrical connection for charging the vehicle can thus be established in a reliable way.

The contacting opening in particular has the shape of the outer contour of the vehicle contact unit.

In one embodiment of the invention, the underfloor charging unit has a contacting actuator provided in the housing of the underfloor charging unit, the contacting actuator being configured to move the vehicle contact unit out of the housing and into the housing. A simple design of the ground unit is thus possible.

In the closed position, the cover for example rests against the vehicle contact unit and arrests the vehicle contact unit, and/or the cover is configured to clean the contacts during movement, and/or the cover is electrically conductive and electrically short-circuits the contacts in the closed position. The cover can thus have further functions such that costs can be reduced.

The cover may be connected to the ground potential of the vehicle such that contacts are grounded by the cover in the closed position.

In one variant embodiment, the underfloor charging unit has a sensor which is configured to detect the position of the cover, in particular to recognize whether the cover is in the closed position, as a result of which malfunctions can be avoided.

In the closed position, the cover can rest against at least one stop of the underfloor charging unit, in particular against a stop in a direction opposite to the direction of travel and/or a stop above the cover to prevent the cover from detaching during travel.

In a further embodiment of the invention, the housing has an outer surface, at least one cleaning device, in particular a cleaning blade being provided on the outer surface such that the inner side of the cover is at least partially, in particular entirely cleaned by the cleaning device when the cover is moved from the open position to the closed position and/or from the closed position to the open position. In this way, it is for example reliably prevented that dirt which has reached the inner side of the cover in the open position is conveyed into the interior of the housing during closing.

The cleaning device extends parallel to the direction of travel, for example, to reduce the flow resistance.

The cleaning device may for example be configured as a brush, a lip or a ledge.

For example, the horizontal movement runs at least partially perpendicularly to the cleaning device so that the cleaning device completely sweeps the inner side.

Furthermore, the object is achieved by a vehicle comprising an underfloor charging unit as described above, the underfloor charging unit being provided below the vehicle, in particular on the vehicle underfloor. The possible embodiments listed for the underfloor charging unit and the advantages apply equally to the vehicle.

For example, the vehicle underfloor spans an underfloor plane, the cover being located on the side of the underfloor plane facing the vehicle in the open position and/or in the closed position. The dimensions of the vehicle are thus not increased by the underfloor charging unit.

The cover can be entirely located on the side of the underfloor plane facing the vehicle, in particular in a position between the closed position and the open position, i.e. during the movement of the cover.

### BRIEF DESCRIPTION OF THE DRAWINGS

Further features and advantages of the invention will become apparent from the description below and from the accompanying drawings to which reference is made and in which:

FIG. 1 schematically shows a vehicle according to the invention having an underfloor charging unit according to the invention,

FIG. 2 shows a schematic basic diagram of the underfloor charging unit according to FIG. 1,

FIG. 3 shows a perspective view of the underfloor charging unit according to FIG. 1,

FIG. 4 shows an embodiment of a cover of the underfloor charging unit according to claim 3,

FIGS. 5a to 5c show a sectional view through the underfloor charging unit according to FIG. 2 in different positions of the cover,

FIG. 6 shows a sectional view of a driving assembly of the underfloor charging unit according to FIG. 2,

FIG. 7 shows a sectional view of a closure device of the underfloor charging unit according to FIG. 2,

FIGS. 8a to 8d show a second embodiment of a driving device for an underfloor charging unit according to the invention,

FIGS. 9a to 9d show the slotted links of the second embodiment according to FIG. 8 in different positions during the opening of the cover,

FIG. 10 shows a schematic representation of a third embodiment of a driving device of the underfloor charging unit,

FIGS. 11a and 11b show a further embodiment of a cover of the underfloor charging unit according to the invention of FIG. 2 in a closed position and in an open position, respectively, and

FIGS. 12a and 12b show a further embodiment of a cover of an underfloor charging unit according to the invention of FIG. 2 in a closed position and in an open position, respectively.

### DETAILED DESCRIPTION

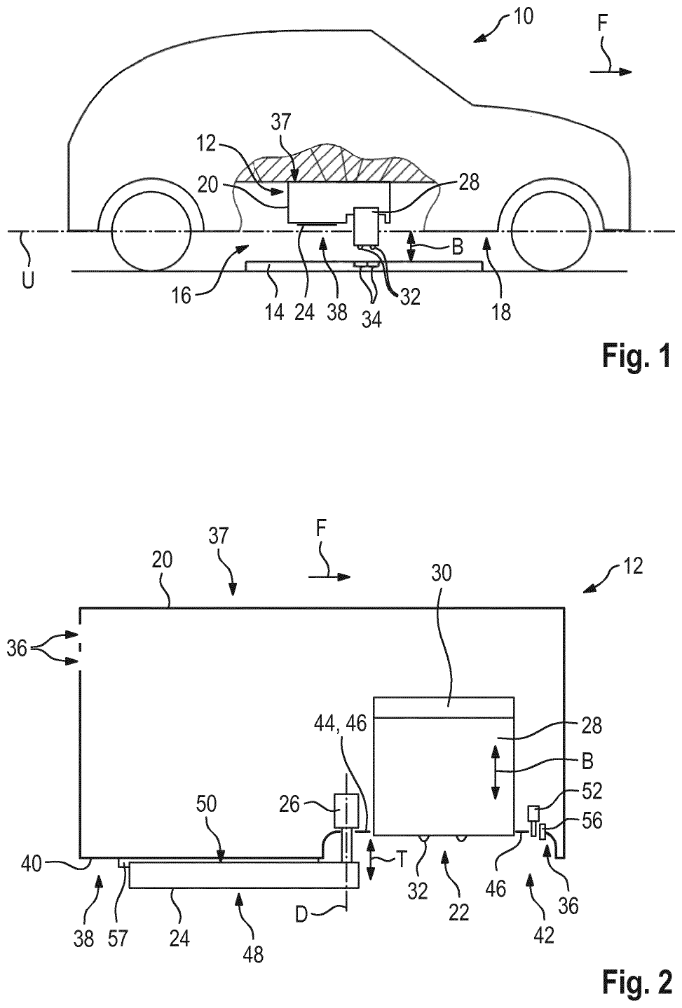

FIG. 1 shows very schematically a vehicle 10 having an underfloor charging unit 12.

The vehicle 10 is parked above a ground contact unit 14, the underfloor charging unit 12 and the ground contact unit 14 forming an electric charging system 16 for the vehicle 10.

The vehicle 10 is an electrically driven vehicle, for example a battery-driven electric vehicle (BEV), a plug-in hybrid vehicle (PHEV) or a fuel cell vehicle (FCEV).

The vehicle 10 comprises a vehicle underfloor 18 to which the underfloor charging unit 12 is fastened. The underfloor charging unit 12 is thus located below the remaining vehicle 10 (with the exception of the vehicle wheels).

The vehicle underfloor 18 defines an underfloor plane U, the vehicle 10 (with the exception of the wheels) being located above the underfloor plane U. This side is also referred to as the side of the underfloor plane U which faces the vehicle 10.

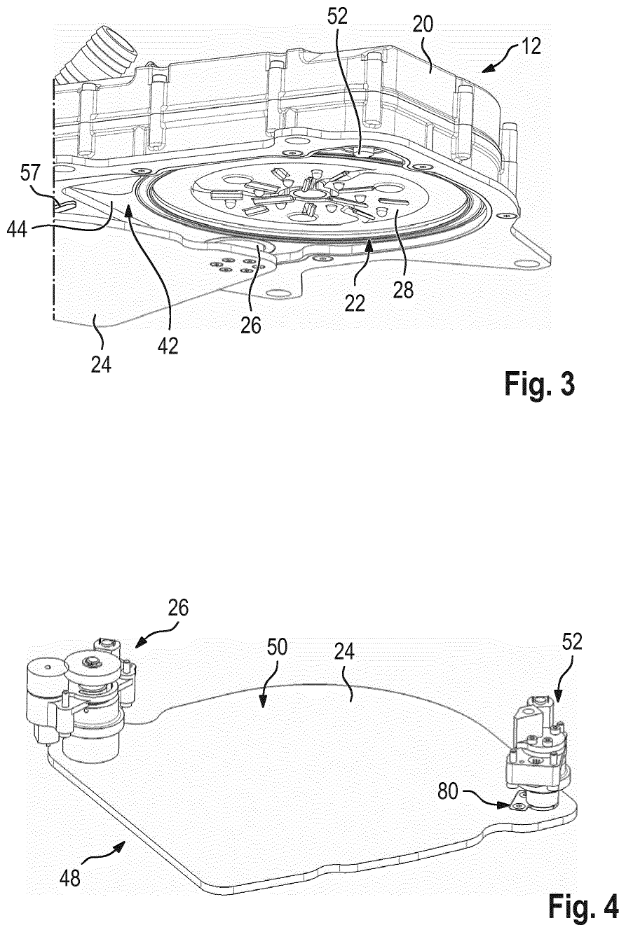

FIGS. 2 and 3 show an enlarged view of the underfloor charging unit 12.

The underfloor charging unit 12 includes a housing 20 having a contacting opening 22, a cover 24, a driving device 26 and a vehicle contact unit 28.

The vehicle contact unit 28 is provided in the interior of the housing, i.e. within the housing 20 and can be moved downwards out of the housing 20 through the contacting opening 22 by means of a contacting actuator 30 of the underfloor charging unit 12. The movement takes place to such extent that the vehicle contact unit 28 contacts the ground contact unit 14, more precisely the contacts 32 of the vehicle contact unit touch contact surfaces 34 of the ground contact unit 14 to establish a closed electric circuit for charging the vehicle 10.

The contacting opening 22 has the same contour and size as the outer contour of the vehicle contact unit 28 such that the contacting opening 22 is configured as small as possible.

Such vehicle contact units 28 having contacting actuators 30 which may be a pneumatically operated bellows, for example, are known from the prior art.

The housing 20 can comprise a plurality of parts and may for example be manufactured from two half-shells or have a two-box design.

In addition, the housing 20 may also have further openings 36 which are for example ventilation openings and serve to ventilate the interior of the housing.

The housing 20 has an upper side 37 and a lower side 38.

The upper side 37 is the side of the housing 20 which is located at the top and thus for example faces a vehicle roof in the intended mounting position of the underfloor charging unit 12 which is for example shown in FIG. 1.

The lower side 38 faces away from the vehicle 10 and faces the ground when the underfloor charging unit 12 is properly mounted to the vehicle 10. On the lower side 38, the housing 20 has an outer surface 40 which is for example the outer surface of a wall of the housing 20.

A recess 42 having a bottom 44 is furthermore formed on the lower side 38. The bottom 44 extends for example parallel to the remaining outer surface 40 and/or to the underfloor plane U.

In addition, the bottom 44 may be offset towards the vehicle 10, i.e. to the top with respect to the remaining outer surface 40.

The contacting opening 22 is provided in the bottom 44, i.e. sections of the bottom 44 form a marginal area 46 which delimits the contacting opening 22. Further openings 36 such as ventilation openings can also be provided in the bottom 44.

In the example embodiment shown, the cover 24 is configured to be plate-shaped, the contour of the cover 24 corresponding substantially to the contour of the recess 42.

In addition, the thickness or gauge of the cover 24 is substantially as large as the offset of the bottom 44 with respect to the remaining outer surface 40.

As can be seen in FIG. 4, the cover 24 has an outer side 48 and an inner side 50.

The outer side 48 faces away from the housing 20, whereas the inner side faces the housing 20.

On the inner side 50, the driving device 26 is for example connected to the cover 24. A closure device 52 of the underfloor charging unit 12 can also engage the cover 24 via the inner side 50.

As can be seen in FIG. 4, the location on the inner side 50 of the cover 24 where the driving device 26 is connected to the cover 24, and the location where the closure device 52 engages the cover 24 are diametrically opposed with respect to the contacting opening 22 and/or the axis of rotation D.

The cover 24 may be made of metal or have a conductive coating on the inner side 50.

The driving device 26 is provided in the interior of the housing and is arranged in the region of the recess 42. This means that in a view perpendicular onto the contacting opening 22, the driving device 26 is located in the recess 42.

The driving device 26 is connected to the inner side 50 of the cover 24 by a functional opening—for example a further opening 36—in the bottom 44.

The closure device 52 is also provided in the interior of the housing and is arranged in the region of the recess 42. The closure device 52 may also cooperate with the inner side 50 of the cover 24 via a functional opening—for example a further opening 36—in the bottom 44.

A sealing lip 54 which completely surrounds at least the contacting opening 22 in a perpendicular view onto the contacting opening 22 is furthermore provided in the marginal area 46.

The sealing lip 54 is for example made of rubber or felt and can be configured as a bead, as a hollow profile or as a brush. Alternatively or additionally, the sealing lip 54 or a further lip can also be arranged on the cover 24, in particular on the inner side 50.

In the embodiment shown, a cleaning device 57, here in the form of a cleaning blade, is furthermore provided on the housing 20.

The cleaning device 57 is fastened to the lower side 38, for example to the outer surface 40 of the housing 20.

The cleaning device 57 extends parallel to the direction of travel F and is arranged such that the inner side 50 of the cover 24 at least partially, in particular completely wipes over the cleaning device 57 when the cover 24 is moved from the open position to the closed position and/or from the closed position to the open position.

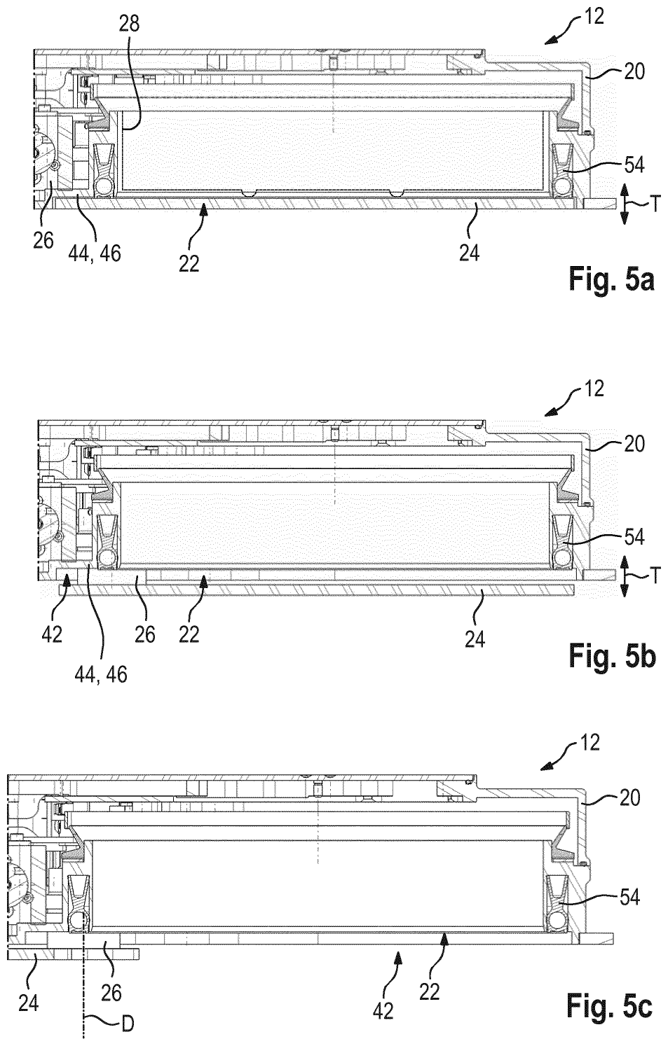

As can be seen in FIGS. 5a to 5c, which illustrate a detailed sectional view through the housing 20, the cover 24 can take various positions relative to the housing 20.

FIG. 5a illustrates the position referred to as closed position, in which the cover 24 completely covers and thus closes the contacting opening 22 so that the interior of the housing is mechanically protected.

In the closed position, the cover 24 is for example completely in the recess 42, such that the outer side 48 of the cover 24 is flush with the outer surface 40. The sealing lip 54 is arranged axially between the cover 24 and the marginal area 46 such that no liquids and/or dirt can enter the interior of the housing.

In the closed position, the interior of the housing is thus mechanically protected.

Furthermore, the marginal area 46 or the bottom 44 forms a stop for the cover 24 above the cover 24.

The step between the outer surface 40 and the bottom 44 forms a stop for the cover 24 in a direction opposite to the direction of travel F, against which the cover 24 rests such that the cover 24 is not moved relative to the housing 20 during travel even in case of strong vibrations.

In the closed position, the cover 24 can furthermore be mechanically arrested, for example by the closure device 52, as will be explained below.

The vehicle contact unit 28 along with the contacts 32 thereof is arranged within the housing behind the contacting opening 22 (illustrated in a dashed line in FIG. 5a), such that the cover 24 covers the contacts 32 of the vehicle contact unit 28.

The contacts 32 can touch the inner side 50 such that the contacts are electrically short-circuited and are in particular connected to the ground potential.

For this purpose, the cover 24 may be made of a conductive material or have an electrically conductive coating on the inner side 50. The cover 24 and/or the conductive coating are then connected to the ground potential.

The cover 24 can be transferred in an automated manner by the driving device 26 into its open position via an intermediate position, as illustrated in FIG. 5c.

In the open position, the contacting opening 22 is unblocked, i.e. in a view of the underfloor charging unit 12 from the bottom, at least 80%, in particular the entire contacting opening 22 is visible in the open position.

In the open position, the vehicle contact unit 28 can then be shifted through the contacting opening 22 by means of the contacting actuator 30, as indicated in FIGS. 1 and 2.

By comparing FIGS. 5a and 5c, it is clearly visible that in the closed position, the cover 24 is located closer to the upper side 37 than in the open position by a distance. The offset between the open position and the closed position is greater than the thickness of the cover 24 in the vertical direction.

The movement from the closed position to the open position and from the open position to the closed position is generated in an automated manner by the driving device 26.

The horizontal movement for unblocking the contacting opening 22 takes place substantially parallel to the vehicle underfloor 18 or the underfloor plane U.

In the example embodiment shown, and as can be seen in FIG. 1, the cover 24 is located on the side of the underfloor plane U which faces the vehicle in the open position and in the closed position and in the position therebetween.

The cover 24 may be configured such that the contacts 32 of the vehicle contact unit 28 are cleaned during the movement of the cover 24, for example by providing cleaning means on the inner side 50.

Furthermore, the underfloor charging unit 12 may have a sensor 56 which detects the position of the cover 24. The sensor 56 is in particular configured so as to check whether the cover 24 is in the closed position.

The sensor 56 is an optical sensor or a contact sensor, for example.

The movement from the closed position according to FIG. 5a to the open position according to FIG. 5c is first performed by a translational movement in a direction of translation T.

The direction of translation T is in particular perpendicular to the contacting opening 22 and may correspond to the direction of movement B of the vehicle contact unit 28.

The vertical movement of the cover 24, here a translational movement, occurs first away from the interior of the housing, i.e. towards the underfloor plane U until the cover has completely left the recess 42. This position is shown in FIG. 5b.

A horizontal movement, for example a rotational movement about an axis of rotation D which is also generated by the driving device 26 then takes place. The axis of rotation D extends parallel to the direction of translation T and is therefore also perpendicular to the contacting opening 22 and the cover 24.

The cover 24 is rotated until the open position in FIG. 5c is reached.

The horizontal movement of the cover 24 extends parallel such that the cover 24 always runs parallel to the vehicle underfloor 18 or the underfloor plane U and also to the outer side 48 of the housing 20.

In its open position, the cover 24 is in particular arranged parallel to the outer side 48 of the housing 20.

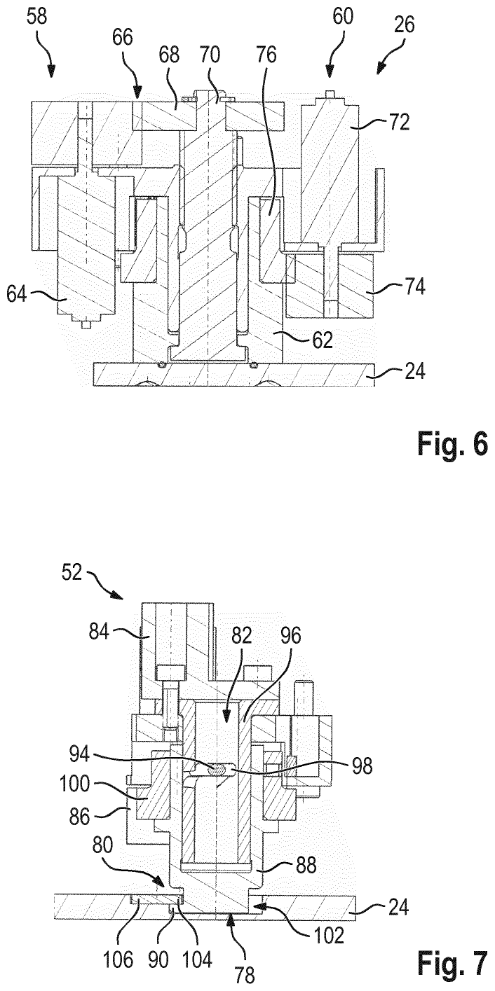

One embodiment of the driving device 26 which provides both the translational movement and the rotational movement is shown in a section in FIG. 6.

The driving device 26 includes a first assembly 58 for generating the translational movement and a second assembly 60 for generating the rotational movement, and a fastening piece 62.

The driving device 26 is fastened to the cover 24 by means of the fastening piece 62.

The first assembly 58 has a first electric motor 64, a first gear stage 66 and a helical gearing 68 having a shiftable component 70.

The helical gearing 68 is for example a spindle drive, wherein the shiftable component 70 may be a threaded spindle. The spindle drive itself, i.e. the helical gearing 68 may represent the gear stage 66.

The shiftable component 70, the threaded spindle in the embodiment shown, is firmly connected to the fastening piece 62.

By operating the first electric motor 64, the helical gearing 68 is actuated, the fastening piece 62 and the cover 24 fastened thereto being thus moved in the direction of translation T.

The second assembly 60 includes a second electric motor 72 having a motor-side toothed wheel 74 and a cover-side toothed wheel 76 which is connected to the fastening piece 62 for joint rotation therewith.

The shiftable component 70, for example the threaded spindle, in particular extends through the cover-side toothed wheel 76.

In this case, the axis of rotation D extends through the threaded spindle or the shiftable component 70. The cover-side toothed wheel 76 is thus arranged concentrically with respect to the shiftable component 70 or entirely surrounds the shiftable component 70 in the circumferential direction.

To generate the rotational movement, the second electric motor 72 is actuated, as a result of which the fastening piece 62 and thus the cover 24 fastened thereto is rotated about the axis of rotation D.

It is of course also conceivable that the driving device 26 has only one electric motor which constitutes the first electric motor and the second electric motor 64, 72. It is also conceivable that the one or the first electric motor 64 and the second electric motor 72 drive further components of the underfloor charging unit 12.

For transferring the cover 24 from the closed position (FIG. 5a) to the open position (FIG. 5c), the first electric motor 64 is thus first actuated until the position shown in FIG. 5b is reached. The first electric motor 64 is then switched off and the second electric motor 72 is activated such that the cover 24 is rotated into the open position.

To transfer the cover 24 in an automated manner from the open position to the closed position, first the second electric motor 72 is activated and then the first electric motor 64 is activated.

The inner side 50 of the cover 24 moves at least partially, in particular entirely over the cleaning device 57 such that dirt is wiped off the inner side 50 and does not enter the interior of the housing.

As soon as the cover 24 is again within the recess 42, the closure device 52 can be activated to reach the final closed position of the closure device 52. This is illustrated in a section in FIG. 7.

In the example embodiment shown, the closure device 52 has a locking element 78 which can engage in a closure area 80 on the inner side 50 of the cover 24.

A closure recess 102 is provided in the closure area 80 in the cover 24, a projection 104 projecting on one side into the closure recess 102, thus producing an undercut.

The projection 104 can be formed by a plate 106 inserted into the cover 24.

Furthermore, the closure device 52 has a receptacle 82 for the locking element 78, a closure motor 84, in particular an electric motor, and a toothed wheel 86.

The locking element 78 has an elongated base body 88 having a lip 90.

The lip 90 is provided at the end of the base body 88 which faces the cover 24 and extends radially outwards. However, the lip 90 only partially surrounds the base body 88.

The base body 88 is configured hollow at the end opposite the lip 90 and has there a guide pin 94 which extends radially inwards.

A pin guide 96 having a slotted link 98 is formed in the receptacle 82 of the closure device 52. The pin guide 96 is inserted into the base body 88, and the guide pin 94 of the base body 88 engages in the slotted link 98.

A toothed wheel 100 which meshes with the toothed wheel 86 is at the same time fastened to the outer side of the base body 88.

When the closure motor 84 is actuated, the base body is thus caused to rotate, as a result of which the guide pin 94 follows the path determined by the slotted link 98 and thus moves the base body 88.

The slotted link 98 first has a first section extending in the axial direction and an adjoining second section extending in the circumferential direction.

The guide pin 94 first runs in the first section of the slotted link 98 such that an axial movement of the guide pin 94 and thus of the base body 88 is achieved with a simultaneous rotation.

The base body 88 can thus be moved towards the cover 24.

The slotted link 98 is configured such that when the base body 88 entirely engages in the closure recess 102, the first section is passed by the guide pin 94 and the guide pin is now guided only in the circumferential direction in the second section. This means that only a rotation of the base body 88 still takes place.

The base body 88 and in particular the lip 90 thus rotates in the closure recess 102 until the lip 90 engages behind the undercut produced by the projection and the cover 24 is thus arrested.

It is of course also conceivable that the closure device 52 is integrated in the cover 24. For example, closure means which engage in the housing 20 in the closed position may be provided on the cover 24.

The closure motor 84 along with the pin guide 96 may be regarded as an actuator which is configured to first move the base body 88 in the axial direction towards the cover 24 and subsequently to rotate it.

It is of course also conceivable that the closure device 52 is magnetic. In this case, it is for example possible to provide a magnet in the closure device 52 and a magnetic counterpart such as a ferromagnetic material or a magnet in the cover 24.

The magnet in the closure device 52 may be a solenoid which is turned on to arrest the cover 24. It is also conceivable that the magnet of the closure device 52 is a permanent magnet, the driving device 26 being adapted to overcome the magnetic force acting between the permanent magnet and the magnetic counterpart.

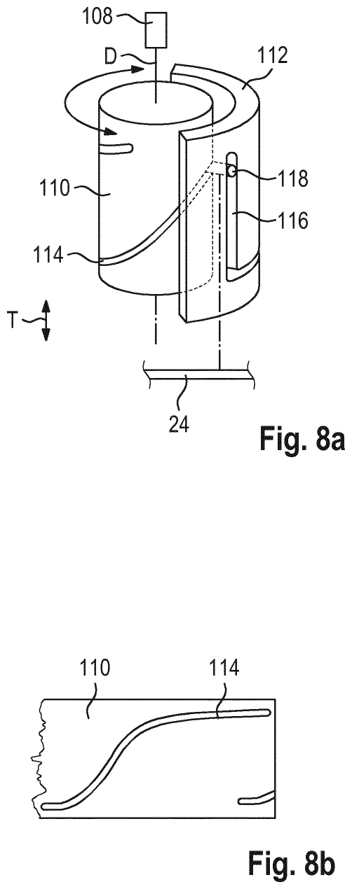

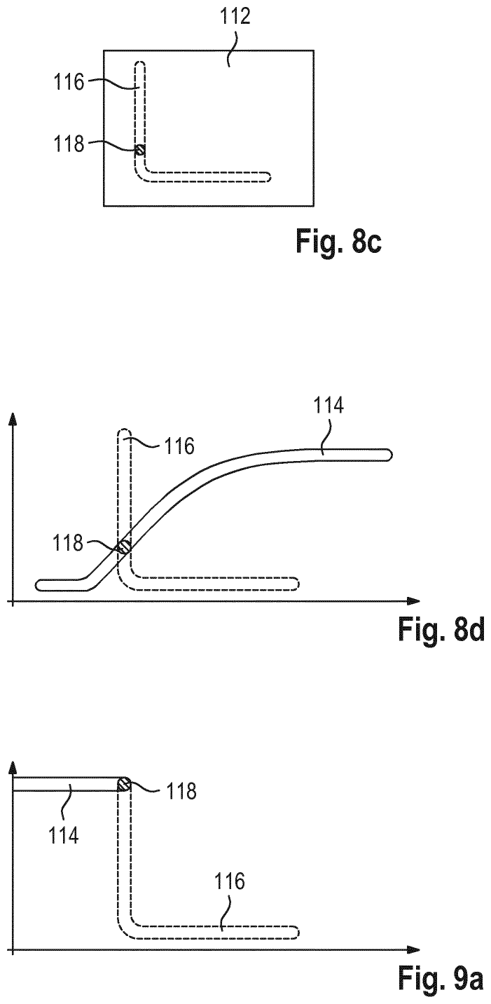

Further embodiments of the underfloor charging unit 12 which substantially correspond to the first embodiment according to FIGS. 1 to 7 are partially described in FIGS. 8 to 10. Therefore, only the differences will be discussed below, and identical parts or parts having the same function are provided with the same reference numerals.

FIGS. 8a to 8d illustrate part of a driving device 26 according to a second embodiment.

In this embodiment, the driving device includes only one assembly which is driven by a single electric motor 108.

In this second embodiment, the driving device 26 has a cylindrical or conical slotted link component 110 which may be a threaded rod. The slotted link component 110 is surrounded by a slotted link wall 112 in the circumferential direction. For reasons of simplicity, only part of the slotted link wall 112 is illustrated in FIG. 8a.

The slotted link component 110 is rotatable relative to the slotted link wall 112 and may for example be driven by the electric motor 108.

The slotted link wall 112 is stationary, i.e. it is fixed relative to the housing 20.

A first slotted link 114 is formed on the circumferential wall of the slotted link component 110 and is illustrated unrolled in FIG. 8b.

The first slotted link 114 extends at its two ends substantially in the horizontal direction, i.e. in the circumferential direction. The two ends are however axially offset to each other such that a section of the first slotted link 114 extends between these ends, which extends at least partially in the axial direction.

In the example embodiment shown, the first slotted link 114 is approximately S-shaped.

The slotted link wall 112 has a second slotted link 116 of the driving device 26, which faces the slotted link component 110. In FIG. 8c, this slotted link is illustrated unrolled.

It is clearly visible that the second slotted link 116 includes a first substantially axially extending section and a second substantially circumferentially extending section, which permits the separate generation of the translational movement and the rotational movement of the cover 24.

The ends of the first slotted link 114 are located at the same axial height as the corresponding ends of the second slotted link 116.

A common guide pin 118 is simultaneously inserted in the first slotted link 114 and in the second slotted link 116 so as to be forced-guided by both slotted links 114, 116.

The guide pin 118 is for example connected to the cover 24 by means of the fastening piece 62.

This means that the cover 24 performs the same movement as the guide pin 118.

Only the simplest case will be described to explain the operating principle.

Of course, the slotted link wall 112 can also entirely surround the slotted link component 110 in the circumferential direction. Two identical diametrically opposed first slotted links 114 may be provided on the slotted link component 110, and two identical diametrically opposed second slotted links 116 may be provided on the slotted link wall 112, for example.

In this case, two guide pins 118 may be present, or a guide pin 118 extends radially through the slotted link component 110 and is located in all four slotted links 114. 116.

It is of course also conceivable that the slotted link wall 112 is driven and the slotted link component 110 is stationary.

In FIG. 8d, the first slotted link 114 and the second slotted link 116 are shown in a superimposed manner. The guide pin 118 is also illustrated, a movement of the guide pin 118 along the y-axis corresponding to an axial movement of the guide pin 118 and thus of the cover 24. A movement of the guide pin 118 along the x-axis corresponds to a movement of the guide pin in the circumferential direction and thus to a rotation of the guide pin 118 and of the cover 24 about the axis of rotation D.

As the slotted link component 110 is movable relative to the slotted link wall 112, the first slotted link 114 is also movable relative to the second slotted link 116, such that the relative position of the two slotted links 114, 116 illustrated in FIG. 8d is variable.

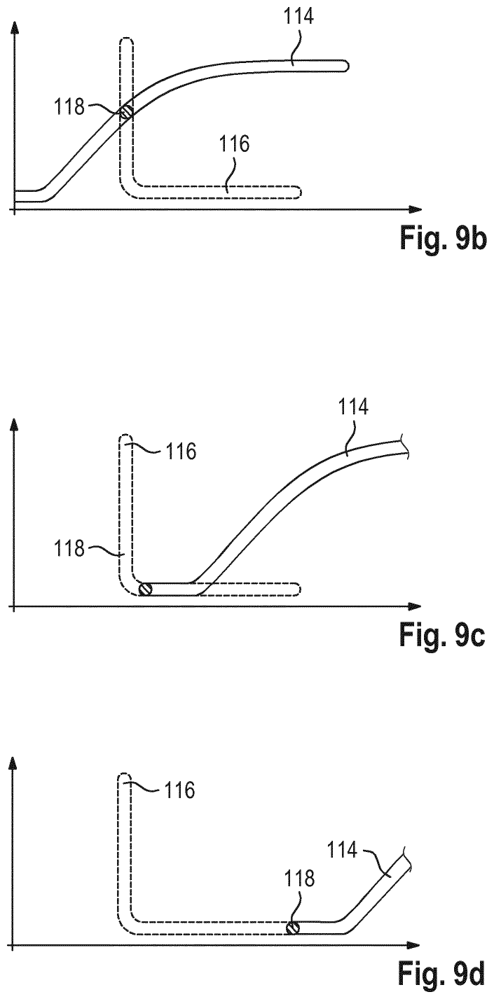

FIGS. 9a to 9d show the operating principle of this driving device 26 according to the second embodiment, FIG. 9a corresponding to the closed position of the cover 24 and FIG. 9d to the open position.

As can be seen in FIG. 9a, the guide pin 118 is first located at the respective upper ends of the first slotted link 114 and of the second slotted link 116.

If the slotted link component 110 and thus the first slotted link 114 is rotated with respect to the slotted link wall 112 by means of the electric motor 108, for example, the guide pin 118 passes through the first slotted link 114 as it is prevented from moving in the circumferential direction by the second slotted link 116.

Due to the axially extending section of the first slotted link 114, the guide pin 118 is moved axially downwards through the axial section of the second slotted link 116, as shown in FIG. 9b.

While the guide pin 118 passes through the first section of the second slotted link 116, the guide pin and the cover 24 perform the vertical translational movement in the direction of translation T.

At the end of the axially extending section of the first slotted link 114, the guide pin 118 is located in the second slotted link 116 at the transition between the first axial section and the second section in the circumferential direction.

If the slotted link component 110 and the slotted link wall 112 are rotated further relative to each other, the guide pin 118 in the first slotted link 114 reaches the end of the first slotted link 114 and is then circumferentially entrained by the end of the first slotted link 114, as can be seen in FIG. 9c. In other words, the axially lower end of the first slotted link 114 now pulls the guide pin 118 through the second section of the second slotted link 116.

At the same time, both the guide pin 118 and the cover 24 connected thereto are rotated about the axis of rotation D, such that the horizontal rotational movement occurs.

For transferring the cover 24 from the open position to the closed position, the direction of rotation of the electric motor 108 and thus the direction of rotation of the slotted link component 110 is inversed, causing the guide pin 118 to pass through the second slotted link 116 in the opposite direction. The cover 24 is thus first rotated back and then moved axially into the recess 42.

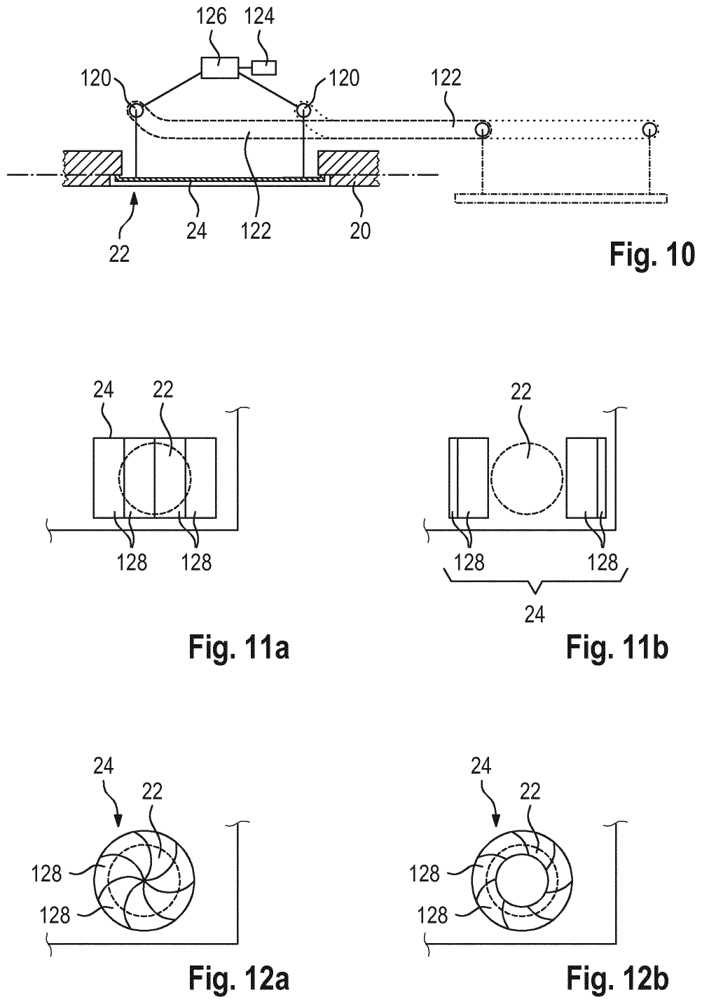

FIG. 10 schematically shows a third embodiment of the driving device 26.

In this third embodiment, the cover 24 is guided in slotted links 122 by means of guide pins 120.

The slotted links 122 run substantially parallel to the outer surface 40 of the housing 20 or to the underfloor plane U. A partially axially extending section is provided merely at one end which is assigned to the closed position.

To move the cover 24, the guide pins 120 or the fastening piece 62 are/is moved translationally parallel to the outer surface 40. This movement is for example generated by one single electric motor 124 and a helical gearing 126, for example a spindle drive. In FIG. 10, the cover 24 is completely shown in the closed position, and is shown in the open position by a dot-dash line.

Here, in the closed position, the cover 24 is also located closer to the upper side 37 than in the open position by a distance, the distance being greater than the thickness of the cover in the vertical direction.

The guide pins 120 are first also moved in the axial direction out of the closed position through the sections of the slotted links 122 which also run in the axial direction, as a result of which the translational movement in the direction of translation T is obtained.

A translational movement parallel to the outer surface 40 or the underfloor plane U then takes place to remove the cover 4 from the contacting opening 22 and unblock the latter.

FIG. 11 shows various further embodiments of the cover 24. The covers 24 shown in FIGS. 11a and 11b have a plurality of cover parts 128 which together form the cover 24.

The cover parts 128 are movable relative to each other and can overlap each other to unblock the contacting opening 22 and thus reach the open position.

In FIG. 11, the cover parts 128 are rectangular and can be slid one on top of the other (cf. FIG. 11b) to unblock the cover.

The overlapping can be realized such that the center of mass of all cover parts 128 together and thus the center of mass of the cover 24 is closer to the upper side in the closed position than in the open position. This is for example the case if the cover parts 128 are shifted one on top of each other.

In the embodiment of FIG. 12, the cover parts 128 form a cover which is similar to an iris diaphragm, the iris diaphragm being shown in the closed position in FIG. 12a and in the open position in FIG. 12d.

To arrest the cover 24 and the cover parts 128, the cover parts 128 can have closure means which engage each other in the closed position.

The features of the embodiments shown can of course be combined with each other in any way. In particular, the different covers shown can be used along with the various driving devices shown.

In the various embodiments, the movement of the cover 24 is always guided by a guide. For example, this involves the slotted links 114, 116 and 122 or, as in the first embodiment, a shaft bearing of the driving device 26, for example a shaft bearing which supports the fastening piece 62.

In a plan view 22 of the contacting opening 22 from the bottom, the sealing lip 54 surrounds these guides also in the closed position to avoid a contamination of the guides.

In the closed position, the sealing lip 54 can also surround the closure device 52.

1. An underfloor charging unit, in particular for an electric charging system for an electrically driven vehicle, comprising a housing having an upper side and a contacting opening, a cover, and a driving device for actuating the cover,
the cover covering the contacting opening in a closed position and unblocking the contacting opening in an open position,
the driving device being configured so as to move the cover in an automated manner from the closed position to the open position and from the open position to the closed position,
the cover, in the closed position, being arranged closer to the upper side than in the open position.

2. The underfloor charging unit according to claim 1, wherein the driving device is configured so as to move the cover from the driving device translationally and/or rotationally about an axis of rotation, the driving device being configured to first move the cover translationally in a direction of translation away from the interior of the housing and then move the cover rotationally about an axis of rotation into the open position to transfer the cover from the closed position to the open position.

3. The underfloor charging unit according to claim 2, wherein the axis of rotation and/or the direction of translation extend(s) perpendicularly to the cover and/or to the contacting opening.

4. The underfloor charging unit according to claim 1, wherein the cover has a plurality of cover parts which are movable relative to each other.

5. The underfloor charging unit according to claim 1, wherein the cover has an outer side and an inner side, the cover being connected to the driving device on the inner side.

6. The underfloor charging unit according to claim 1, wherein the contacting opening is delimited by a marginal area of the housing, the underfloor charging unit having a sealing lip which, in the closed position, is arranged between the cover and the marginal area and surrounds the contacting opening.

7. The underfloor charging unit according to claim 1, wherein the underfloor charging unit has a guide and/or a shaft bearing which guides the movement of the cover.

8. The underfloor charging unit according to claim 6, wherein the sealing lip surrounds the guide in the closed position.

9. The underfloor charging unit according to claim 1, wherein the housing includes an outer surface having a recess, the contacting opening being provided in the recess.

10. The underfloor charging unit according to claim 9, wherein the recess has a bottom, at least parts of the bottom forming a marginal area of the housing which delimits the contacting opening.

11. The underfloor charging unit according to claim 9, wherein in the closed position, the cover is at least partially received in the recess.

12. The underfloor charging unit according to claim 9, wherein the driving device is provided in the region of the recess in the interior of the housing.

13. The underfloor charging unit according to claim 1, wherein the driving device includes at least one assembly (58, 60) for generating the movement of the cover.

14. The underfloor charging unit according to claim 1, wherein the driving device includes a first slotted link and a different second slotted link in which a common guide pin is guided, the first slotted link being movable relative to the second slotted link.

15. The underfloor charging unit according to claim 14, wherein the first slotted link is provided on a slotted link component and the second slotted link is provided on a slotted link wall, the slotted link wall surrounding the slotted link component in the circumferential direction, and the slotted link component being rotatable relative to the slotted link wall, or vice versa.

16. The underfloor charging unit according to claim 1, wherein the underfloor charging unit has a closure device for arresting the cover in the closed position.

17. The underfloor charging unit according to claim 16, wherein the cover includes a closure area which is arranged in the region of the closure device in the closed position.

18. The underfloor charging unit according to claim 1, wherein the underfloor charging unit includes a vehicle contact unit having contacts which is arranged in the housing.

19. The underfloor charging unit according to claim 18, wherein the underfloor charging unit has a contacting actuator provided in the housing of the underfloor charging unit, the contacting actuator being configured to move the vehicle contact unit out of the housing and into the housing.

20. The underfloor charging unit according to claim 18, wherein in the closed position, the cover rests against the vehicle contact unit and arrests the vehicle contact unit is configured to clean the contacts during movement, and/or in that the cover is electrically conductive and electrically short-circuits the contacts in the closed position.

21. The underfloor charging unit according to claim 1, wherein the underfloor charging unit has a sensor which is configured to detect the position of the cover.

22. The underfloor charging unit according to claim 1, wherein in the closed position, the cover rests against at least one stop of the underfloor charging unit.

23. The underfloor charging unit according to claim 1, wherein the housing has an outer surface, at least one cleaning device being provided on the outer surface such that the inner side of the cover is at least partially cleaned by the cleaning device when the cover is moved from the open position to the closed position and/or from the closed position to the open position.

24. A vehicle comprising an underfloor charging unit according to claim 1, the underfloor charging unit being provided below the vehicle.

25. The vehicle according to claim 24, wherein the vehicle underfloor spans an underfloor plane, the cover being located on the side of the underfloor plane facing the vehicle in the open position and/or in the closed position.
